(19) United States
(12) Patent Application Publication
(10) Pub. No.: US 2025/0389089 A1
(43) Pub. Date: Dec. 25, 2025

(54) OPERATOR STATION SYSTEM FOR AN OPERATING MACHINE

(71) Applicant: Hamm AG, Tirschenreuth (DE)

(72) Inventor: Claus Zant, Tirschenreuth (DE)

(21) Appl. No.: 19/240,137

(22) Filed: Jun. 17, 2025

(30) Foreign Application Priority Data
Jun. 19, 2024 (DE) 10 2024 117 232.0

(51) Int. Cl. E01C 19/26

(52) U.S. Cl. CPC E01C 19/26; E01C 2301/30

(57) ABSTRACT

A control station system for an operating machine, in particular a self-propelled ground processing machine, includes a suspension support arrangement which is to be fixed to a machine frame of an operating machine, and a control station which is mounted on the suspension support arrangement such that it can be displaced in a first displacement direction by a movement system and can rotate about an axis of rotation. The control station is suspended from the suspension support arrangement in an upper region of the control station in a vertical direction by the movement system.

The present invention relates to an operator station system for an operating machine.

U.S. Pat. No. 7,204,546 B2 discloses an operator station system for an operating machine, in which an operator station is supported on a machine frame of the operating machine by means of a movement system in such a way that the operator station can be displaced in a displacement direction with respect to the machine frame and can be rotated with respect to the machine frame about an axis of rotation which is essentially orthogonal to the displacement direction. The movement system is coupled on the one hand to the machine frame and on the other hand to a lower region of the operator station in a vertical direction, i.e. essentially a vertical direction, so that the operator station stands on the machine frame via the movement system.

U.S. Pat. No. 5,386,119 discloses an operator station system in which an operator station is supported suspended on a suspension support arrangement. In order to enable an essentially vertical orientation of the operator station which compensates for this inclination when an operating machine moves in inclined terrain, the operator station is suspended on the suspension support arrangement via a plurality of telescopic suspension units.

It is the object of the present invention to provide an operator station system for an operating machine, in particular a self-propelled ground processing machine, which allows a defined positioning of an operator station with extensive mobility.

According to the invention, this object is achieved by an operator station system for an operating machine, in particular a self-propelled ground processing machine, comprising:
a suspension support arrangement to be fixed to a machine frame of an operating machine,
an operator station which is supported by means of a movement system on the suspension support arrangement so as to be displaceable in a first displacement direction and rotatable about an axis of rotation,
wherein the operator station is suspended from the suspension support arrangement in an upper region of the operator station in a vertical direction by means of the movement system.

The operator station system according to the invention makes it possible to position an operator station with respect to a machine frame of an operating machine in a multiplicity of positions produced by displacement in the first displacement direction and rotation about the axis of rotation. This enables an operator to position the operator station in such a way that an area to be processed, for example the soil to be compacted, can be observed in an optimum manner. Since the operator station is integrated into an operating machine suspended via the suspension support arrangement, the operator station will position itself in a stable manner, in particular due to unavoidable play of movement, also under the action of gravity. At the same time, the introduction of shocks into the operator station can be significantly reduced in comparison with a support of the operator station standing on a machine frame, in particular when damping suspension components are used.

For a stable configuration, the suspension support arrangement can comprise two suspension supports arranged at a distance from one another in the first displacement direction.

In order to be able to generate a defined displacement movement, it is proposed that the movement system comprises a displacement rail arrangement which is supported on the suspension support arrangement and is elongated in the first displacement direction, and a displacement slide which is supported displaceably on the displacement rail arrangement in the first displacement direction, and that the operator station is suspended on the displacement slide in a manner such that it can rotate about the axis of rotation.

A defined positioning of the operator station can be supported in that the displacement rail arrangement comprises at least two, preferably rod-like, displacement rails arranged at a distance from one another transversely to the first direction of displacement.

In the case of a configuration of the suspension support arrangement with two suspension supports, the displacement rail arrangement can be supported on one of the suspension supports in each case at end regions positioned at a distance from one another in the first direction of displacement.

In order to be able to generate the movement of the operator station in the first displacement direction, the movement system can comprise a displacement drive for moving the displacement slide along the displacement rail arrangement in the first displacement direction.

The displacement drive can comprise a displacement belt which is coupled to the displacement slide, extends in the first displacement direction and can be driven by a belt drive for movement in the first displacement direction.

In order to achieve a mechanically stable configuration of the displacement drive, which can nevertheless be operated reliably, the displacement belt can be an endless displacement belt guided around deflection rollers, preferably toothed rollers, and the belt drive can comprise, in association with at least one of the deflection rollers, a displacement drive motor for driving the associated deflection roller for rotation about a roller rotation axis.

For a stable configuration and an exact positioning of the operator station, the displacement belt can comprise a belt, preferably a toothed belt, or a chain.

In the embodiment of the suspension support arrangement with two suspension supports, one of the deflection rollers can be rotatably supported on each suspension support.

In order to generate the rotary movement of the operator station, the movement system can comprise a preferably pin-like suspension element, which is rotatably supported on the displacement slide about the axis of rotation, on the upper region of the operator station in the vertical direction, and a rotary drive motor on the displacement slide for driving the suspension element for rotation about the axis of rotation.

The introduction of shocks into the suspended operator station can be further reduced in that the operator station is coupled to the suspension element by means of an operator station suspension, wherein the operator station suspension comprises a plurality of coupling supports which extend radially outwards with respect to the axis of rotation from the suspension element and are coupled to the upper region of the operator station in the vertical direction by means of at least one elastic coupling element in coupling regions arranged at a radial distance from the suspension element.

The suspension support arrangement can comprise a first suspension support arrangement region extending in a straight line or curved substantially in the height direction and a second suspension support arrangement region extending substantially transversely to the height direction in order to overlap the operating position in the height direction and substantially transversely to the height direction, wherein the first suspension support arrangement region is designed in a lower end region in the height direction for fixing to the machine frame and is connected to the second suspension support arrangement region in an upper end region in the height direction.

In the embodiment of the suspension support arrangement with two suspension supports, each suspension support can comprise a first suspension support part and a second suspension support part, wherein then the first suspension support arrangement region comprises the first suspension support parts and the second suspension support arrangement region comprises the second suspension support parts.

An expansion of the range of movement of the operator station can be achieved in an advantageous further development of the operator station system according to the invention in that the first suspension support arrangement region is designed for pivotable fastening to the machine frame, wherein the first suspension support arrangement region is assigned a first pivotal drive for pivoting the first suspension support arrangement region with respect to the machine frame, and/or in that the second suspension support arrangement region is pivotably connected to the first suspension support arrangement region, wherein the second suspension support arrangement region is assigned a second pivotal drive for pivoting the second suspension support arrangement region with respect to the first suspension support arrangement region. The pivoting of the first suspension support arrangement region with respect to the machine frame carrying the same and a pivoting of the second suspension support arrangement region which is triggered in this case also make it possible to provide various further positions which the operator station can assume with respect to the machine frame independently of the displacement movement in the first displacement direction and independently of the rotary movement about the axis of rotation.

The forces required for pivoting the suspension support arrangement regions and also for maintaining a defined positioning of the same can be provided, for example, by at least one pivoting drive comprising at least one piston/cylinder unit.

The range of motion and thus also the range of positions of the operator station can be further expanded by supporting the movement system on the suspension support arrangement in a second displacement direction so as to be displaceable essentially transversely to the first displacement direction. If, for example, the first displacement direction is oriented essentially transversely to a longitudinal direction of the machine and thus also to a direction of movement of an operating machine, the second displacement direction can be oriented essentially in the longitudinal direction of the machine.

In order to be able to carry out this movement in the second direction of movement, the movement system can comprise a displacement unit in association with each suspension support, the displacement rails being supported in each of their end regions on a displacement unit and one of the deflection rollers being supported on each displacement unit.

Furthermore, a movement system drive can be provided for displacing the movement system in the second displacement direction.

In order to be able to displace the entire movement system in a defined manner in the second displacement direction by means of the movement system drive, the movement system drive can comprise a displacement unit drive, preferably a piston/cylinder unit, in association with each displacement unit.

In order to prevent the occurrence of a pendulum movement of the operator's position, particularly at relatively high movement speeds of the operating machine, a guide system can be provided for guiding the operator's position in a lower region of the operator's position in the vertical direction during movement in the first displacement direction and/or during rotation about the axis of rotation.

The guide system can basically be constructed similarly to the movement system and can comprise a guide rail arrangement which is elongated in the first displacement direction and a guide slide which is supported displaceably on the guide rail arrangement in the first displacement direction, the operator station being supported rotatably about the axis of rotation in its lower region in the vertical direction on the guide slide.

For a stable design of the guide system, it can comprise at least two, preferably rod-like, guide rails arranged at a distance from one another transversely to the first direction of displacement.

The invention further relates to an operating machine, in particular a self-propelled ground processing machine, comprising a machine frame and an operator station system which is mounted on the machine frame and is constructed according to the invention.

For example, the operating machine can be designed as a soil compactor and at least one compactor roller can be rotatably supported on the machine frame.

The present invention is described in detail below with reference to the attached figures. In particular:

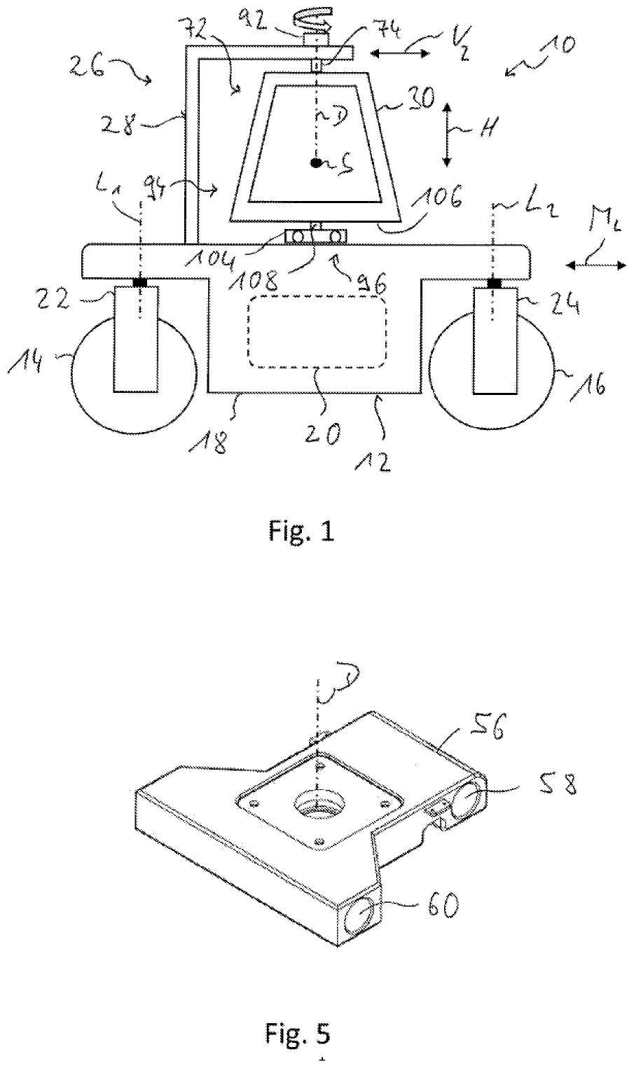

FIG. 1 shows a side view in principle of an operating machine designed as a self-propelled soil compactor;

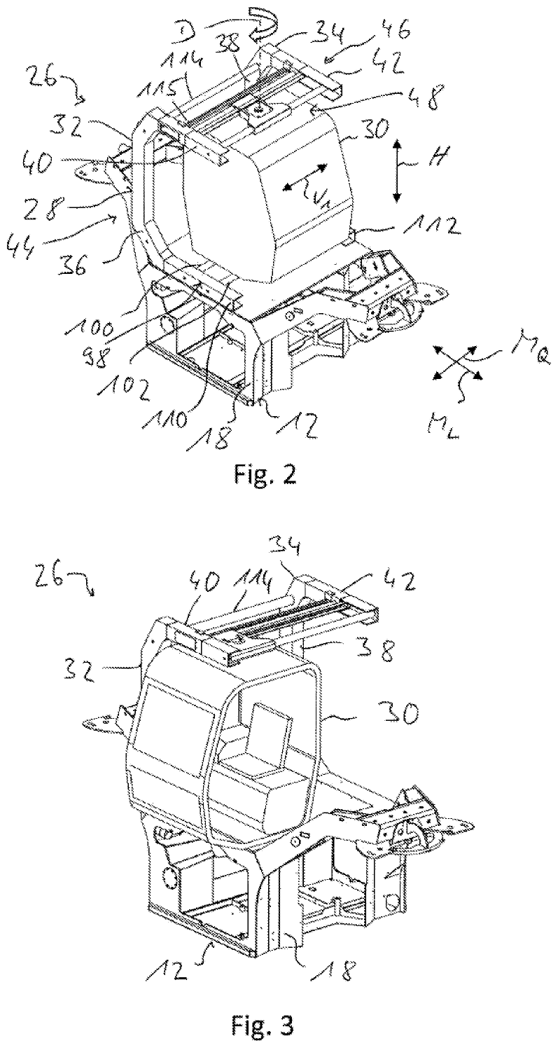

FIG. 2 shows a part of a machine frame of the operating machine of FIG. 1 with an operator station system supported thereon when the operator station is positioned in a neutral position;

FIG. 3 shows a representation corresponding to FIG. 2 with the operator station laterally displaced and rotated;

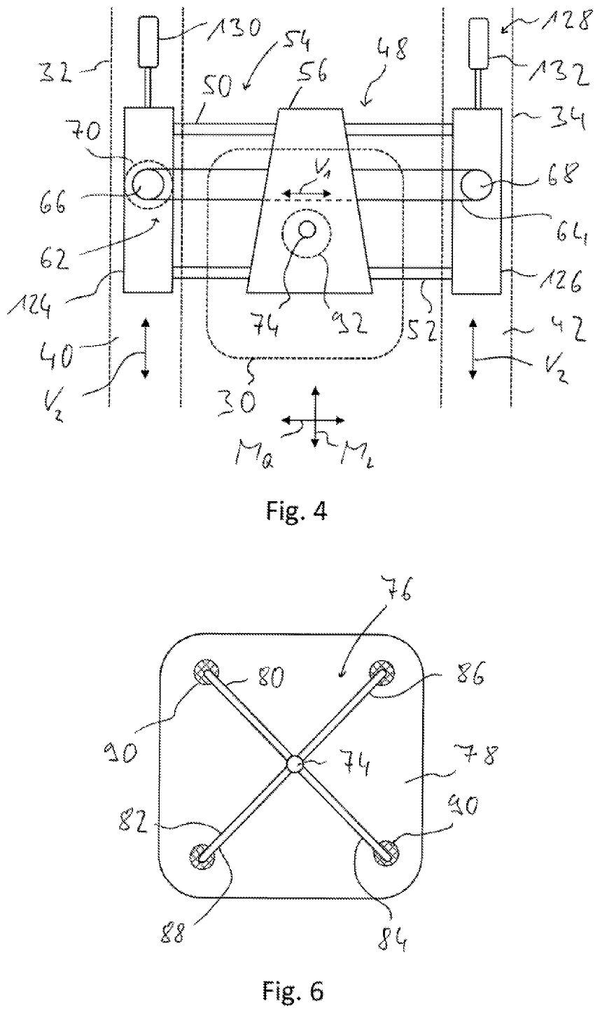

FIG. 4 shows a representation in principle of a movement system of the operator station system of the operating machine of FIG. 1;

FIG. 5 shows a perspective view of a displacement slide of the movement system of FIG. 4;

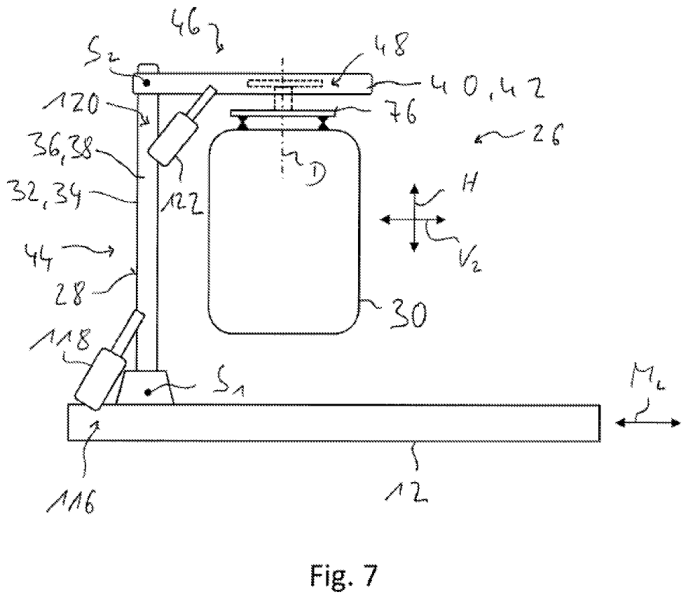

FIG. 6 shows a principled top view of the operator station of the operating machine of FIG. 1 with an operator station suspension provided in a roof region of the operator station; FIG. 7 shows a principled side view of a further development of the operator station system of the operating machine of FIG. 1.

In FIG. 1, an operating machine shown in a principled side view is generally designated 10. In the exemplary embodiment shown, the operating machine 10 is designed as a self-propelled soil compactor which has on a machine frame 12 two compactor rollers 14, 16 rotatable about respective roller axes of rotation. The operating machine 10, which is constructed in the illustrated exemplary embodiment as a pivot-steered compactor, comprises a main frame 18, on which, for example, a drive unit 20 is also provided, and comprises, in association with each compactor roller 14, 16, a sub-frame 22, 24, which is supported on the main frame 18 so as to be pivotable about a respective steering axis L1, L2 and which provides a steering pedestal. By driving at least one compactor roller 14, 16, the operating machine 10 can move in a machine longitudinal direction M_{L} over the substrate to be compacted.

On the machine frame 12, in particular the main frame 18 thereof, there is provided an operator station system 26, described in detail below, having a suspension support arrangement 28 connected to the machine frame 12 and an operator station 30 supported suspended on the suspension support arrangement 28.

Before the construction of the operator station system 26 is discussed below, it should be pointed out that such an operator station system 26 can also be used in differently designed operating machines 10, in particular also in differently constructed soil compactors, such as a roller train or the like.

FIGS. 2 and 3 show in greater detail the machine frame 12 or the main frame 18 thereof with the operator station system 26 supported thereon. The suspension support arrangement 28 comprises two suspension supports 32, 34 which are arranged at a distance from one another in a transverse direction M_{Q} of the machine and each comprise a first support frame part 36, 38 which is fixed to the machine frame 12 in a lower region in a height direction H, that is to say essentially in a vertical direction, and a second support part 40, 42 which starts from a respective upper end region of the same and extends essentially orthogonally to the vertical direction H. The first support parts 36, 38 of the suspension supports 32, 34 thereby form a first suspension support arrangement region 44, and the second suspension support parts 40, 42 of the two suspension supports 32, 34 form a second suspension support arrangement region 46, on which, as also described below, the operator station 30 is suspended in such a way that it can be rotated about an axis of rotation D extending essentially in the height direction H, that is to say essentially in the vertical direction, and can be displaced in a first displacement direction V₁, which corresponds essentially to the transverse machine direction M_{Q}.

In order to generate these different movements of the operator station 30 with respect to the machine frame 12, the operator station system 26 further comprises a movement system 48 shown in more detail in FIG. 4. The movement system 48 comprises a displacement rail arrangement 54 constructed in the illustrated example with two rod-like displacement rails 50, 52. The two displacement rails 50, 52 extend substantially in the first displacement direction V₁ or the transverse machine direction Mo and also substantially orthogonally to the vertical direction H, so that the first displacement direction V₁ is oriented substantially in a horizontal plane. In their two longitudinal end regions, the displacement rails 50, 52 are supported on the second suspension support parts 40, 42 of the two suspension supports 28, 30.

A displacement slide 56 is supported displaceably in the first displacement direction V₁ on the two displacement rails 50, 52. In association with each of the two displacement rails 50, 52, the displacement slide 56 has a displacement opening 58, 60, in which a respective displacement rail 50, 52 is accommodated, for example with the interposition of a respective bearing arrangement, in such a way that the displacement slide 56 is displaceable along the displacement rails 50, 52, which are designed, for example, with a circular cross-section.

In order to be able to generate the displacement of the displacement slide 56 in the first displacement direction V₁, a displacement drive 62 is associated with the latter. The displacement drive 62 comprises an endless displacement belt 64, for example in the form of a belt, in particular a toothed belt or chain. In the region of the suspension supports 28, 30 or the second suspension support parts 40, 42 thereof, the endless displacement belt 64 is guided around respective deflection rollers 66, 68. For example, in the association with the deflection roller 66, a displacement drive motor 70 is provided, for example, in the form of an electric motor. The deflection roller 66 can be coupled, for example, directly or via a gear transmission to a drive shaft of the displacement drive motor 70. By excitation of the displacement drive motor 70 providing a belt drive of the endless displacement belt 64, the deflection roller 66 is set in rotation so that the endless displacement belt 64 moves correspondingly in the first displacement direction V₁ with its extension sections lying between the two deflection rollers 66, 68. As indicated by a dash line in FIG. 4, the displacement slide 56 is coupled to one of these extension sections, so that a corresponding movement of the displacement slide 56 in the first displacement direction V₁ is also produced by moving the endless displacement belt 64.

In an upper region 72 of the operator station 30 in the vertical direction H, the operator station is rotatably supported about an axis of rotation D on the displacement slide 56 by means of a suspension element 74, which is designed, for example, in the manner of a pin. The pin-like suspension element 74 is coupled, for example, to a roof region 78 of the operator station 30 via an operator station suspension 76 in the region 72 of the operator station 30 which is upper in the vertical direction. In the embodiment shown, the operator station suspension 76 comprises four coupling supports 80, 82, 84, 86 extending radially inwardly and radially outwardly with respect to the axis of rotation D or the suspension element 74. These are connected in their radially inner region to the suspension element 74 substantially rigidly, for example by screwing, welding or the like, and are connected in their respective coupling region 88, which is arranged further radially outwardly, to the operator station 30 in the roof region 78 via a respective coupling element 90. The coupling elements 90 are constructed elastically or with an elastic material, such as rubber material or the like, so that the operator station 30 is suspended on the suspension support arrangement 28 via the operator station suspension 76 in a vibration-damping manner.

The suspension element 74 is rotatably supported in the displacement slide 56 about the axis of rotation D, for example by means of a corresponding bearing. In association with the suspension element 74, a rotary drive motor 92, designed for example as an electric motor, is supported on the displacement slide 56. The rotary drive motor 92 or its output shaft can be coupled to the suspension element 74 directly or via a gear transmission or the like, so that by excitation of the rotary drive motor 92 the suspension element 74 and with it the operator station 30 can be rotated about the axis of rotation D.

Since the operator station 30 is coupled to the displacement slide 56 exclusively via the suspension element 74 or is suspended therefrom, the suspension element 74 is positioned with respect to the operator station 30 in such a way that, in the vertical direction H, i.e. essentially in the vertical direction, the suspension element 74 is positioned essentially directly above the center of mass S of the operator station 30, so that the axis of rotation D also extends through the center of mass S in the vertical direction H. Due to a generally existing play of movement in the region of the suspension bearing of the suspension element 74 on the displacement slide 56 and the elastic coupling of the operator station suspension 76 to the operator station 30 by means of the elastic coupling elements 90, the operator station 30 will in principle position itself such that its center of mass S will lie directly below the region of the suspension, i.e. below the suspension element 74.

In order to prevent the occurrence of a pendulum movement of the operator station 10, particularly at relatively high movement speeds of the operating machine 10, the operator station system 26 can comprise a guide system 96 for guiding the operator station 30 in a lower region 94 of the same in the vertical direction during movement in the first displacement direction V₁ and/or during rotation about the axis of rotation D. The guide system 96 can in principle be constructed similarly to the movement system 48 and comprises a guide rail arrangement 98 having two guide rails 100, 102 which extend in the first displacement direction V₁ and are arranged at a distance from one another transversely to the first displacement direction V₁ and on which a guide slide 104 is guided movably in the first displacement direction V₁. A guide element, e.g. a pin-like guide element 108 provided, for example, on a bottom region 106 of the operator's console 30 is received in an associated opening of the guide slide 104 so as to be rotatable about the axis of rotation D.

The two guide rails 100, 102 are fixed in their longitudinal end regions to respective third suspension support parts 110, 112 of the suspension supports 32, 34, so that the suspension supports 32, 34 with the respective first, second and third parts thereof have in principle a C-shaped structure. Since the displacement rails 50, 52 of the displacement rail arrangement 54 can also be rigidly connected to the suspension supports 32, 34, an inherently stable and rigid structure of the suspension support arrangement 28 is provided. In order to achieve additional stiffening here, further stiffening elements 114, 115 can be arranged at different positions between the suspension supports 32, 34 or can be rigidly connected to these in each case.

By means of the guide system 96, the operator station 30 is guided in a defined manner in its region 94, which is lower in the vertical direction, during the movement in the first displacement direction V₁ or also during the rotational movement about the axis of rotation D, it being possible to further suppress the occurrence of pendulum movements by virtue of the fact that, for example, damping or friction elements act between the guide slide 104 and the guide rails 102, which damping or friction elements admittedly permit essentially free movement of the guide slide 104 in the first displacement direction V₁, but prevent the occurrence of vibrations. With the guide element 108, the operator station 30 can in principle be freely rotatable with respect to the guide slide 104. In order to allow a movement of the operator station 30 in the height direction H to at least a small extent, also taking into account the elasticity of the coupling elements 90, the guide element 108 can be freely movable in the height direction H with respect to the guide slide 104. Alternatively, the operator station 30 could also be supported on the guide slide 104 in the vertical direction H, for example by means of elastic support elements which permit rotation of the operator station 30 with respect to the guide slide 104.

In principle, the guide system 96 could also be designed in such a way that the guide slide 104 can be driven for movement in the first displacement direction V₁ by an associated guide drive. Such a guide drive could be similarly structured as the displacement drive 62 provided in association with the movement system 48 and could be operated synchronously with it.

A further development of the operator station system 26 is illustrated in FIG. 7. While in the operator station system 26, which is also illustrated in FIGS. 2 and 3, the suspension supports 32, 34 with their, for example, C-shaped structure are designed to be inherently rigid, in the further development illustrated in FIG. 7, the first suspension support arrangement region 44 comprising the two first suspension support parts 36, 38 is supported on the machine frame 12 so as to be pivotable about a first pivot axis S₁ which extends essentially horizontally and is therefore orthogonal to the vertical direction H.

In association with the first suspension support arrangement region 44, a first swivel drive, generally designated 116, is provided, which can comprise a piston/cylinder unit 118, for example in association with each of the two suspension supports 32, 34. By activating the piston/cylinder units 118, the first suspension support parts 36, 38 of the suspension supports 32, 34 can be pivoted with respect to the machine frame 12 about the first pivot axis S₁.

The second suspension support parts 40, 42 providing the second suspension support arrangement region 46 are connected to the first suspension support parts 36, 38 of the suspension supports 32, 34 so as to be pivotable about a second pivot axis S₂, the second pivot axis S₂ extending parallel to the first pivot axis S₁. In order to achieve this pivoting, a second pivoting drive 120 is provided, which can comprise a piston/cylinder unit 122 in association with each pair of first suspension support part 36, 38 and second suspension support part 40, 42 By activating the second piston/cylinder units 122, the second suspension support parts 40, 42 and thus the second suspension support arrangement region 46 can be pivoted with respect to the first suspension support parts 36, 38 and thus with respect to the first suspension support arrangement region 44. By means of a coordinated pivoting of the two suspension support arrangement regions 44, 46, with the first suspension support arrangement region 46 being held essentially in a horizontal orientation, the operating console 30 is in principle moved in the longitudinal direction M_{L} of the machine. At the same time, the operator station 30 also moves in the vertical direction H. This movement of the operator station 30 or the positions of the operator station 30 which can be produced thereby with respect to the displacement frame 12 can be superimposed on the displacement movement in the first displacement direction V₁ or the rotary movement about the axis of rotation D or the positions of the operator station 30 which can be produced thereby.

In a further development of the operator station system 28 illustrated in FIG. 4, the entire movement system 48 can be moved in a second displacement direction V₂ which is essentially orthogonal to the first displacement direction V₁, the second displacement direction V₂ being able to correspond essentially to the machine longitudinal direction M_{L}.

In order to be able to achieve this movement, the movement system 48 comprises, in association with each suspension support 32, 34, a displacement unit 124, 126, which is displaceably received in the respective first suspension support part 40, 42, for example via corresponding bearing arrangements, rollers or the like, in the second displacement direction V₂. The displacement rails 50, 52 of the displacement rail arrangement 54 are fixed with their respective longitudinal end regions to the two displacement units 124, 126. Furthermore, one of the two deflection rollers 66, 68 is rotatably supported on each of the displacement units 124, 126. For example, the displacement drive motor 70 provided for driving the deflection roller 66 can be carried on the displacement unit 124.

A movement system drive, generally designated 128, is provided for displacing the displacement units 124, 126 in the second displacement direction V₂. For example, in association with each displacement unit 124, 126, the latter may comprise a displacement unit drive 130, 132, which is designed, for example, as a piston/cylinder unit. By synchronous activation of the displacement unit drives 130, 132, the displacement units 124, 126 and thus the movement system 48 carried thereon are displaced transversely to the first displacement direction V₁ in the second displacement direction V₂, so that the positioning of the operator station 30 with respect to the second suspension support arrangement region 46 changes in the second displacement direction V₂, i.e. essentially in the longitudinal direction M_{L} of the machine.

Such a displacement of the movement system 48 in the second displacement direction V₂ can be provided in the operator station system 26 independently of whether the suspension support arrangement regions 44, 46 are rigidly coupled to the machine frame 12 and to one another, as shown in FIGS. 2 and 3, or are pivotable with respect to the machine frame 12 or with respect to one another, as illustrated in FIG. 7. When the suspension support arrangement regions 44, 46 are rigidly coupled to one another and to the machine frame 12, a guide system 96 guiding the operator station 30 in its lower region 94 in the vertical direction H can also be provided, similarly to what is indicated in FIGS. 1 and 2. In the respective third suspension support parts 110, 112, the latter can comprise guide units corresponding to the displacement units 124, 126, on which the guide rails 100, 102 are fixed with their longitudinal end regions, so that the guide system 96 can follow this displacement as a result of a corresponding displaceability of the guide units in the third suspension support parts 110, 112 when the movement system 48 moves in the second displacement direction V₂. Alternatively, a guide system drive could be associated with the guide system 96, by means of which a corresponding displacement of the guide system 96 in the second displacement direction V₂ is caused synchronously with the displacement of the movement system 48 in the second displacement direction V₂.

If the suspension support arrangement regions 44, 46 are pivotable with respect to one another and with respect to the machine frame 12, as shown in FIG. 7, such a guide system can be dispensed with because of the changes in the height position of the operator station 30 caused by such a pivotal movement. Alternatively, the guide system could be designed in such a way that, for example, with a correspondingly long design of the guide element 108, the latter can also move in 10 the vertical direction H with respect to the guide slide 104 during the vertical movement of the operator station 30, but the engagement of the guide element 108 in the guide slide 104 is nevertheless retained.

1. An operator station system for an operating machine, in particular a self-propelled ground processing machine, comprising:
a suspension support arrangement to be fixed to a machine frame of an operating machine,
an operator station which is supported by means of a movement system on the suspension support arrangement so as to be displaceable in a first displacement direction and rotatable about an axis of rotation,
wherein the operator station is suspended from the suspension support arrangement in an upper region of the operator station in a vertical direction by means of the movement system.

2. The operator station system according to claim 1,
wherein the suspension support arrangement comprises two suspension supports arranged at a distance from one another in the first displacement direction.

3. The operator station system according to claim 1,
wherein the movement system comprises a displacement rail arrangement carried on the suspension support arrangement and elongated in the first direction of displacement and a displacement slide carried on the displacement rail arrangement so as to be displaceable in the first direction of displacement, and in that the control station is suspended on the displacement slide so as to be rotatable about the axis of rotation.

4. The operator station system according to claim 3,
wherein the displacement rail arrangement comprises at least two rod-like displacement rails arranged at a distance from one another transversely to the first displacement direction.

5. The operator station system according to claim 2,
wherein the displacement rail arrangement is supported on one of the suspension supports in each case at end regions which are positioned at a distance from one another in the first displacement direction.

6. The operator station system according to claim 3,
wherein the movement system comprises a displacement drive for moving the displacement slide along the displacement rail arrangement in the first displacement direction.

7. The operator station system according to claim 6,
wherein the displacement drive comprises a displacement belt which is coupled to the displacement slide, extends in the first displacement direction and can be driven by a belt drive for movement in the displacement direction.

8. The operator station system according to claim 7,
wherein the displacement belt is an endless displacement belt guided around deflection rollers, and the belt drive, in association with at least one of the deflection rollers, comprises a displacement drive motor for driving the associated deflection roller for rotation about a roller axis of rotation.

9. The operator station system according to claim 7,
wherein the displacement belt comprises a belt, or a chain.

10. The operator station system according to claim 2,
wherein one of the deflection rollers is rotatably supported on each suspension support.

11. The operator station system according to claim 3,
wherein the movement system comprises a preferably pivot-like suspension element at the upper region of the control station in the height direction, which suspension element is supported on the displacement slide so as to be rotatable about the axis of rotation, and a rotary drive motor on the displacement slide (56>for driving the suspension element to rotate about the axis of rotation.

12. The operator station system according to claim 11,
wherein the control station is coupled to the suspension element by means of a control station suspension, the control station suspension comprising a plurality of coupling regions extending radially outwards away from the suspension element with respect to the axis of rotation and arranged at a radial distance from the suspension element and coupled to the upper region of the control station in the height direction in each case by means of coupling supports coupled by at least one respective elastic coupling element.

13. The operator station system according to claim 2,
wherein the suspension support arrangement comprises a first suspension support arrangement region extending substantially in the height direction and a second suspension support arrangement region extending substantially transversely to the height direction, wherein the first suspension support arrangement region is designed to be fixed to the machine frame in a lower end region in the height direction and is connected to the second suspension support arrangement region in an upper end region in the height direction.

14. The operator station system according to claim 13,
wherein each suspension support comprises a first suspension support part and a second suspension support part, and in that the first suspension support arrangement region comprises the first suspension support parts and the second suspension support arrangement region comprises the second suspension support parts.

15. The operator station system according to claim 13,
wherein the first suspension support arrangement region is designed for pivotable attachment to the machine frame, the first suspension support arrangement region being assigned a first pivot drive for pivoting the first suspension support arrangement region with respect to the machine frame, or/and that the second suspension support arrangement region is pivotably connected to the first suspension support arrangement region, wherein a second pivot drive is associated with the second suspension support arrangement region for pivoting the second suspension support arrangement region with respect to the first suspension support arrangement region.

16. The operator station system according to claim 15,
wherein at least one pivot drive comprises at least one piston/cylinder unit.

17. The operator station system according to claim 3,
wherein the movement system is supported on the suspension support arrangement so as to be displaceable in a second displacement direction substantially transversely to the first displacement direction.

18. The operator station system according to claim 17,
wherein the movement system comprises a displacement unit in association with each suspension support, the displacement rails being supported in each of their end regions on a displacement unit and one of the deflection rollers being supported on each displacement unit.

19. The operator station system according to claim 17,
wherein a movement system drive is provided for displacing the movement system in the second displacement direction.

20. The operator station system according to claim 18,
wherein the movement system drive comprises a displacement unit drive, preferably a piston/cylinder unit, in association with each displacement unit.

21. The operator station system according to claim 1,
wherein a guide system is provided for guiding the operator station in a lower region of the operator station in the vertical direction during movement in the first displacement direction or/and during rotation about the axis of rotation.

22. The operator station system according to claim 21,
wherein the guide system comprises a guide rail arrangement elongated in the first displacement direction and a guide slide supported on the guide rail arrangement so as to be displaceable in the first displacement direction, the control station being supported on the guide slide so as to be rotatable about the axis of rotation in its lower region in the height direction.

23. The operator station system according to claim 22,
wherein the guide system comprises at least two rod-like guide rails arranged transversely to the first direction of displacement at a distance from one another.

24. An operating machine, comprising a machine frame and an operator station system which is mounted on the machine frame and is constructed according to claim 1.

25. The operating machine according to claim 24,
wherein the operating machine can be designed as a soil compactor and at least one compactor roller can be rotatably supported on the machine frame.
